(19) United States
(12) Patent Application Publication
(10) Pub. No.: US 2026/0338360 A1
(43) Pub. Date: Oct. 29, 2026

(54) LIFTING STRUCTURES FOR WAKE-UP LAMPS

(71) Applicant: LONVIS TECHNOLOGY (SHENZHEN) CO., LTD., Shenzhen (CN)

(72) Inventor: Xuequan LI, Shenzhen (CN)

(73) Assignee: LONVIS TECHNOLOGY (SHENZHEN) CO., LTD., Shenzhen (CN)

(21) Appl. No.: 19/650,318

(22) Filed: Apr. 16, 2026

(30) Foreign Application Priority Data
Apr. 25, 2025 (CN) 202520809230.6

(51) Int. Cl. F21V 21/15; F21S 10/00; F21V 21/34; F21V 23/04

(52) U.S. Cl. CPC F21V 21/15; F21S 10/00; F21V 21/34; F21V 23/0492

(57) ABSTRACT

The utility model discloses a lifting structure for a wake-up lamp, including: a guide rail, having at least two different heights and a light source being movably disposed thereon; a rocker, one end of the rocker being rotatably connected to the light source and the other end of the rocker being rotatably connected to a power device, so as to form a structure capable of driving the light source to move along the guide rail; and a control circuit, both the light source and the power device being electrically connected to the control circuit. The utility model can simulate a sun rising process in the morning, effectively improving an effect of simulating sunrise and thus better waking up a user.

### CROSS-REFERENCE TO RELATED APPLICATIONS

The disclosure claims the priority of the Chinese application with application number 202520809230.6 submitted on Apr. 25, 2025. The entire content of the application is hereby incorporated by reference into the document.

### TECHNICAL FIELD

The utility model relates to the field of wake-up lamps, and in particular, to a lifting structure for a wake-up lamp.

### BACKGROUND

Traditional alarm clocks stimulate users through sound waves or vibrations to ensure they wake up on time. However, the sudden stimulation from sound waves or vibrations can easily trigger a rapid increase in heart rate, an imbalance in cortisol level, and residual sleep inertia, and may even cause disturbances to others in a same space. For this reason, wake-up lamps have been launched on the market currently, which can simulate light changes of natural sunrise, and influence secretion of melatonin by gradually increasing brightness before a set get-up time, so as to make the users wake up naturally.

Each existing wake-up lamp generally consists of a housing, a light source, and a control system. For example, the Chinese utility model patent with an application number CN202121806818.4 discloses a multifunctional wake-up lamp, including a housing, a control module disposed in the housing, and a lamplight module connected to the control module, where the lamplight module is capable of receiving a control signal sent by a main control module and gradually brightening to wake up its user. However, the existing wake-up lamps can only simulate intensity changes of light at sunrise, but cannot simulate a sun rising process in the morning, thereby weakening a simulation effect.

How to solve the above problems has become an urgent technical issue to be addressed.

### SUMMARY

An objective of the utility model is to provide a lifting structure for a wake-up lamp, which is capable of simulating a sun rising process in the morning, effectively improving an effect of simulating sunrise and thereby better waking up a user.

In order to achieve the above objective, the utility model adopts the following technical scheme:
the utility model provides a lifting structure for a wake-up lamp, including:
   a guide rail, having at least two different heights and a light source being movably disposed thereon;
   a rocker, one end of the rocker being rotatably connected to the light source and the other end of the rocker being rotatably connected to a power device, so as to form a structure capable of driving the light source to move along the guide rail; and
   a control circuit, both the light source and the power device being electrically connected to the control circuit.

Furthermore, the lifting structure for the wake-up lamp further includes a high-position travel switch and a low-position travel switch, where both the high-position travel switch and the low-position travel switch are electrically connected to the control circuit;
when the light source moves to a high position of the guide rail, the high-position travel switch is abutted against a baffle plate; and
when the light source moves to a low position of the guide rail, the low-position travel switch is abutted against the light source or the rocker.

Furthermore, the lifting structure for the wake-up lamp further includes a housing, where the guide rail, the control circuit, and the low-position travel switch are all fixedly connected to the housing, and the baffle plate is fixedly connected to the guide rail or the housing.

Furthermore, the high-position travel switch is fixedly connected to the light source or fixedly connected to the end of the rocker connected to the light source.

Furthermore, the power device includes a motor and a rotary wheel, where the rotary wheel is coaxially connected to an output shaft of the motor, and the rotary wheel is rotatably connected to the rocker through an eccentric rotating shaft.

Furthermore, the power device includes a motor, a driving gear, and a driven gear, where the driving gear is coaxially connected to the output shaft of the motor, the driven gear is rotatably connected to the rocker through an eccentric rotating shaft, and the driving gear and the driven gear are meshed with each other, or the driving gear is in meshing transmission connection with the driven gear through at least one transmission gear.

Furthermore, the guide rail is an arc-shaped guide rail or a linear guide rail.

Furthermore, the light source is a lamp panel with gradually variable brightness.

By adopting the above structure, the utility model has the following beneficial effects.

The utility model, by disposing the light source on the guide rail, can simulate a scene of sun rising in the morning when the power device drives the light source to move from the lower position to the higher position of the guide rail via the rocker, effectively improving the effect of simulating sunrise, promoting the user to wake up more quickly and effectively, significantly reducing residual sleep inertia, and achieving a better wake-up effect; and can simulate a scene of sun setting in the evening when the power device drives the light source to move from the higher position to the lower position of the guide rail via the rocker, improving the simulation effect and aesthetic appeal, while also subtly prompting the user to fall asleep.

The utility model will become clearer from the following description in conjunction with the accompanying drawings, which are intended to explain embodiments of the utility model.

### BRIEF DESCRIPTION OF THE DRAWINGS

To more clearly explain the technical schemes in the embodiments of the utility model, the drawings to be used in the description of the embodiments or the existing technology will be briefly introduced below. Obviously, the drawings in the description below are only some embodiments of the utility model. Those having ordinary skill in the art may also obtain other drawings according to these drawings without contributing creative labor.

FIG. 1 is an overall structural schematic diagram of the utility model.

Reference numerals: Guide rail–1, Light source–2, Rocker–3, Control circuit–4, High-position travel switch–5, Low-position travel switch–6, Baffle plate–7, Motor–8, Driving gear–9, Driven gear–10, Transmission gear–11.

### DETAILED DESCRIPTION

The technical schemes in the embodiments of the utility model will be described clearly and completely below in conjunction with the drawings in the embodiments of the utility model. Obviously, the described embodiments are only some, but not all of the embodiments of the utility model. All other embodiments obtained by those having ordinary skill in the art based on the embodiments of the utility model without contributing creative labor belong to the protection scope of the utility model.

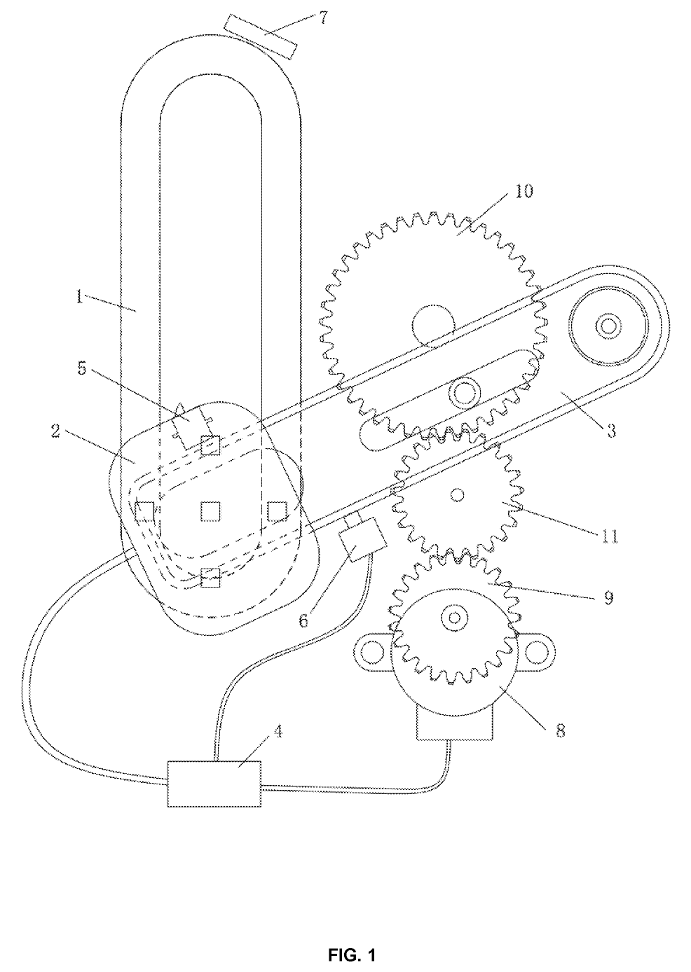

Referring to FIG. 1, this embodiment provides a lifting structure for a wake-up lamp, including:
a guide rail 1, having at least two different heights and a light source 2 being movably disposed thereon, where the lifting structure for the wake-up lamp can simulate a scene of sun rising in the morning in a process in which the light source 2 moves from a lower position to a higher position of the guide rail 1, providing a user with a subtle cue to get up, further promoting the user to wake up, effectively reducing residual sleep inertia, and achieving a better wake-up effect; and
can simulate a scene of sun setting in the evening in the process in which the light source 2 moves from the higher position to the lower position of the guide rail 1, improving an effect of simulating sunset and aesthetic appeal, especially can also subtly prompt the user to fall asleep if the user observes a sunset scene before going to bed, thereby promoting better sleep;
a rocker 3, one end of the rocker 3 being rotatably connected to the light source 2 and the other end of the rocker 3 being rotatably connected to a power device, so as to form a structure capable of driving the light source 2 to move along the guide rail 1, thereby simulating the scene of sun rising or setting; and
a control circuit 4, both the light source 2 and the power device being electrically connected to the control circuit 4.

Preferably, the guide rail 1 is an arc-shaped guide rail or a linear guide rail, so that different sun movement trajectories can be simulated.

Preferably, the light source 2 is a lamp panel with gradually variable brightness. For example, the light source 2 is a light-emitting diode (LED) lamp panel, a halogen lamp panel, or an incandescent lamp panel.

In this embodiment, the lifting structure for the wake-up lamp further includes a high-position travel switch 5 and a low-position travel switch 6, where both the high-position travel switch 5 and the low-position travel switch 6 are electrically connected to the control circuit 4;
when the light source 2 moves to a high position of the guide rail 1, the high-position travel switch 5 is abutted against a baffle plate 7, and the high-position travel switch 5 feeds information back to the control circuit 4, which in turn controls the motor 8 to stop moving, thus completing a sun rising process; and
when the light source 2 moves to a low position of the guide rail 1, the low-position travel switch 6 is abutted against the light source 2 or the rocker 3, and the low-position travel switch 6 feeds information back to the control circuit 4, which in turn controls the motor 8 to stop moving, thus completing a sun setting process.

In this embodiment, the lifting structure for the wake-up lamp further includes a housing (not shown), where the guide rail 1, the control circuit 4, and the low-position travel switch 6 are all fixedly connected to the housing, and the baffle plate 7 is fixedly connected to the guide rail 1 or the housing. The housing belongs to the prior art and is not a key protection point of the utility model. For a specific structure of the housing, reference may be made to a front shell and a rear shell disclosed in the patent with a patent number CN202323351513.0, titled “Wake-Up Lamp”, which will not be repeated herein.

It can be understood that the guide rail 1, the control circuit 4, the low-position travel switch 6, etc. can also be fixed by a structure such as a frame.

In this embodiment, the high-position travel switch 5 is fixedly connected to the light source 2 or fixedly connected to the end of the rocker 3 connected to the light source 2. Consequently, when moving along the guide rail 1, the light source 2 can drive the high-position travel switch 5 to move synchronously; and when the light source 2 moves to the high position of the guide rail 1, the high-position travel switch 5 moves to the high position of the guide rail 1 synchronously, and is abutted against the baffle plate 7.

As a first optional embodiment, the power device includes a motor 8, a driving gear 9, and a driven gear 10, where the driving gear 9 is coaxially connected to an output shaft of the motor 8, the driven gear 10 is rotatably connected to the rocker 3 through an eccentric rotating shaft, and the driving gear 9 and the driven gear 10 are meshed with each other, so that the motor 8 can drive the driven gear 10 to rotate via the driving gear 9, driving the rocker 3 to swing and further driving the light source 2 to move along the guide rail 1.

The driven gear 10 is rotatably connected to the housing through a central rotating shaft.

On the basis of the above embodiment, as a preferred embodiment, the driving gear 9 is in meshing transmission connection with the driven gear 10 through at least one transmission gear 11, so that the motor 8 can drive the rotary wheel to rotate via the driving gear 9 and the transmission gear 11 sequentially, driving the rocker 3 to swing and further driving the light source 2 to move along the guide rail 1.

The transmission gear 11 is rotatably connected to the housing through a central rotating shaft.

Preferably, the motor 8 may be a reversible motor, and the motor 8 is fixedly connected to the housing.

As a second optional embodiment, the power device includes a motor 8 and a rotary wheel, where the rotary wheel is coaxially connected to a output shaft of the motor 8, and the rotary wheel is rotatably connected to the rocker 3 through an eccentric rotating shaft, so that the motor 8 can drive the rotary wheel to rotate, driving the rocker 3 to swing and further driving the light source 2 to move along the guide rail 1.

### Operating principle:

Within a preset time period, the control circuit 4 activates the light source 2 and the motor 8; as the brightness of the light source 2 gradually increases, the rocker 3 swings and drives the light source 2 to ascend along the guide rail 1 until the high-position travel switch 5 is abutted against the baffle plate 7, and the high-position travel switch 5 feeds information back to the control circuit 4, which in turn controls the motor 8 to stop moving; and in this case, the brightness of the light source 2 also reaches its maximum, thus completing the scene of simulating sunrise. After simulating sunrise is completed, following a preset duration or a preset action (such as pressing a preset control button, setting a new wake-up time point, reaching a preset time point, or the like), the control circuit 4 activates the motor 8 and adjusts the brightness of the light source 2, the rocker 3 swings and drives the light source 2 to descend along the guide rail 1 until the low-position travel switch 6 is abutted against the light source 2 or the rocker 3, and the low-position travel switch 6 feeds information back to the control circuit 4, which in turn controls the motor 8 to stop moving; and in this case, the light source 2 is also turned off by the control circuit 4, thus completing the scene of simulating sunset.

The preferred embodiments of the utility model have been described above. It should be understood that the utility model is not limited to the specific implementations described above. Devices and structures not described in detail herein shall be construed as being implemented in a conventional manner in the art. Any person familiar with this field may make numerous possible changes and modifications to the technical schemes of the utility model using the methods and technical contents disclosed above or modify same into equivalent embodiments with equivalent variations without departing from the scope of the technical schemes of the utility model, which shall not affect the essential content of the utility model. Therefore, any simple modifications, equivalent variations or alterations made to the above embodiments based on the technical essence of the utility model without departing from the technical content of the utility model still fall within the scope of protection of the technical schemes of the utility model.

What is claimed is:

1. A lifting structure for a wake-up lamp, comprising:
a guide rail (1), having at least two different heights and a light source (2) being movably disposed thereon;
a rocker (3), one end of the rocker (3) being rotatably connected to the light source (2) and the other end of the rocker (3) being rotatably connected to a power device, so as to form a structure capable of driving the light source (2) to move along the guide rail (1); and
a control circuit (4), both the light source (2) and the power device being electrically connected to the control circuit (4).

2. The lifting structure for the wake-up lamp according to claim 1, further comprising: a high-position travel switch (5) and a low-position travel switch (6), wherein both the high-position travel switch (5) and the low-position travel switch (6) are electrically connected to the control circuit (4);
when the light source (2) moves to a high position of the guide rail (1), the high-position travel switch (5) is abutted against a baffle plate (7); and
when the light source (2) moves to a low position of the guide rail (1), the low-position travel switch (6) is abutted against the light source (2) or the rocker (3).

3. The lifting structure for the wake-up lamp according to claim 2, further comprising: a housing, wherein the guide rail (1), the control circuit (4), and the low-position travel switch (6) are all fixedly connected to the housing, and the baffle plate (7) is fixedly connected to the guide rail (1) or the housing.

4. The lifting structure for the wake-up lamp according to claim 2, wherein the high-position travel switch (5) is fixedly connected to the light source (2) or fixedly connected to the end of the rocker (3) connected to the light source (2).

5. The lifting structure for the wake-up lamp according to claim 4, wherein the power device comprises a motor (8) and a rotary wheel, wherein the rotary wheel is coaxially connected to an output shaft of the motor (8), and the rotary wheel is rotatably connected to the rocker (3) through an eccentric rotating shaft.

6. The lifting structure for the wake-up lamp according to claim 4, wherein the power device comprises a motor (8), a driving gear (9), and a driven gear (10), wherein the driving gear (9) is coaxially connected to the output shaft of the motor (8), the driven gear (10) is rotatably connected to the rocker (3) through an eccentric rotating shaft, and the driving gear (9) and the driven gear (10) are meshed with each other, or the driving gear (9) is in meshing transmission connection with the driven gear (10) through at least one transmission gear (11).

7. The lifting structure for the wake-up lamp according to claim 4, wherein the guide rail (1) is an arc-shaped guide rail or a linear guide rail.

8. The lifting structure for the wake-up lamp according to claim 4, wherein the light source (2) is a lamp panel with gradually variable brightness.
